(19) United States
(12) Patent Application Publication
(10) Pub. No.: US 2025/0220566 A1
(43) Pub. Date: Jul. 3, 2025

(54) METHOD AND DEVICE FOR SUPPORTING TRAFFIC OFFLOADING OF EDGE COMPUTING ROAMING SERVICE IN A WIRELESS COMMUNICATION SYSTEM

(71) Applicant: Samsung Electronics Co., Ltd., Gyeonggi-do (KR)

(72) Inventors: Hyesung KIM, Gyeonggi-do (KR); Jicheol LEE, Gyeonggi-do (KR)

(21) Appl. No.: 19/009,381

(22) Filed: Jan. 3, 2025

(30) Foreign Application Priority Data
Jan. 3, 2024 (KR) 10-2024-0000925

(51) Int. Cl. H04W 48/18; H04L 61/4511; H04L 61/5007; H04W 84/04

(52) U.S. Cl. CPC H04W 48/18; H04L 61/4511; H04L 61/5007; H04W 84/042

(57) ABSTRACT

The disclosure relates to a fifth generation (5G) or sixth generation (6G) communication system for supporting higher data rates. A method of processing a control signal in a wireless communication system includes receiving a first control signal transmitted from a BS, processing the received first control signal, and transmitting, to the BS, a second control signal generated based on the processing.

### CROSS-REFERENCE TO RELATED APPLICATION(S)

This application is based on and claims priority under 35 U.S.C. § 119 to Korean Patent Application No. 10-2024-0000925, which was filed in the Korean Intellectual Property Office on Jan. 3, 2024, the disclosure of which is incorporated herein by reference in its entirety.

### BACKGROUND

### 1. Field

The disclosure relates generally to an operation of a terminal and a base station (BS) in a wireless communication system, and more specifically, to a method and device for offloading traffic of an edge computing service of a roaming terminal in a mobile communication system.

### 2. Description of Related Art

Fifth generation (5G) mobile communication technology defines a wide frequency band to enable a fast transmission speed and new services, and may be implemented not only in a sub 6 gigahertz (GHz) frequency band of 6 GHz or less, but also in an ultra high frequency band above 6 GHz and referred to as a millimeter wave (mmWave) band such as 28 GHz and 39 GHz bands. Further, in 6G mobile communication technology, which is referred to as a beyond 5G system, to achieve a transmission speed that is 50 times faster than that of 5G mobile communication technology and ultra-low latency reduced to 1/10 compared to that of 5G mobile communication technology, implementations in terahertz (THz) bands, such as 95 GHz to 3 THz bands are being considered.

Since the beginning of 5G mobile communication technology, to satisfy the service support and performance requirements for an enhanced mobile broadband (eMBB), ultra-reliable low-latency communications (URLLC), and massive machine-type communications (mMTC), standardization has been performed for beamforming and massive multi-input multi-output (MIMO) for mitigating a path loss of radio waves in an ultra-high frequency band and increasing a propagation distance of radio waves, support for various numerologies (multiple subcarrier spacing operation, etc.) for efficient use of ultra-high frequency resources and dynamic operation for slot formats, initial access technology for supporting multi-beam transmission and broadband, a definition and operation of a band-width part (BWP), a new channel coding method such as a low density parity check (LDPC) code for large capacity data transmission and polar code for high reliable transmission of control information, layer 2 (L2) pre-processing, and network slicing that provides a dedicated network specialized for specific services.

Discussions are ongoing to improve initial 5G mobile communication technology and enhance a performance thereof in consideration of services in which 5G mobile communication technology was intended to support, and physical layer standardization for technologies such as vehicle-to-everything (V2X) for helping driving determination of an autonomous vehicle and increasing user convenience based on a location and status information of the vehicle transmitted by the vehicle, new radio unlicensed (NR-U) for a system operation that meets various regulatory requirements in unlicensed bands, NR user equipment (UE) power saving, a non-terrestrial network (NTN), which is direct UE-satellite communication for securing coverage in regions where communication with a terrestrial network is impossible, and positioning is in progress.

Standardization in the field of air interface architecture/protocol for technologies such as industrial Internet of things (IIoT) for supporting new services through linkage and convergence with other industries, integrated access and backhaul (IAB) that provides nodes for expanding network service regions by integrating wireless backhaul links and access links, mobility enhancement including conditional handover and dual active protocol stack (DAPS) handover, and 2-step random access channel (RACH) for NR that simplifies a random access procedure is also in progress, and standardization in the field of system architecture/service for 5G baseline architecture (e.g., service based architecture, service based interface) for applying network functions virtualization (NFV) and software-defined networking (SDN) technologies, mobile edge computing (MEC) that receives services based on a location of a UE, etc., is also in progress.

When such a 5G mobile communication system is commercialized, connected devices in an explosive increase trend will be connected to communication networks; thus, it is expected that function and performance enhancement of a 5G mobile communication system and integrated operation of connected devices will be required. To this end, new research on extended reality (XR) for efficiently supporting augmented reality (AR), virtual reality (VR), mixed reality (MR), etc., 5G performance improvement and complexity reduction using artificial intelligence (AI) and machine learning (ML), AI service support, metaverse service support, and drone communication will be conducted.

The development of such a 5G mobile communication system will be the basis for the development of full duplex technology for improving frequency efficiency and system network of 6G mobile communication technology, satellite, AI-based communication technology that utilizes AI from a design stage and that realizes system optimization by internalizing end-to-end AI support functions, and next generation distributed computing technology that realizes complex services beyond the limits of UE computing capabilities by utilizing ultra-high-performance communication and computing resources as well as a new waveform for ensuring coverage in a THz band of 6G mobile communication technology, full dimensional MIMO (FD-MIMO), multi-antenna transmission technologies such as an array antenna and large scale antenna, metamaterial-based lenses and antennas for improving coverage of THz band signals, high-dimensional spatial multiplexing technology using orbital angular momentum, and reconfigurable intelligent surface (RIS) technology.

While many advances have been made in wireless communications, there is a need in the art for a device and method capable of effectively supporting traffic offloading of a user plane function (UPF) controlled by a home session management function (H-SMF) in a roaming environment in the wireless communications.

### SUMMARY

The disclosure has been made to address at least the above-mentioned problems and/or disadvantages and to provide at least the advantages described below.

Accordingly, an aspect of the disclosure is to provide a method and device capable of effectively providing a service in a mobile communication system.

An aspect of the disclosure is to address traffic offloading in an edge computing system using a roaming service.

The present disclosure relates to wireless communication systems and, more specifically, the present disclosure relates to supporting traffic offloading of edge computing roaming service in a wireless communication system.

In accordance with an aspect of the disclosure, a method performed by a home session management function (H-SMF) entity located in a home public land mobile network (HPLMN) region in a communication system, the method comprising: selecting a user plane function (UPF) entity for a user equipment (UE) located in a visited public land mobile network (VPLMN) region; transmitting, to the selected UPF entity, a request message for a N4 session establishment; and as a response to the request message, receiving, from the selected UPF entity, a response message including local domain name system (DNS) server information of the UE.

In accordance with an aspect of the disclosure, a method performed by a user plane function (UPF) entity controlled by a home session management function (H-SMF) entity in a communication system, the method comprising: receiving, from the H-SMF entity located in a home public land mobile network (HPLMN) region, a request message for a N4 session establishment; as a response to the request message, transmitting, to the H-SMF entity, a response message including local domain name system (DNS) server information of the UE; and transmitting, to a user equipment (UE) located in a visited public land mobile network (VPLMN) region, a protocol data unit (PDU) session.

In accordance with an aspect of the disclosure, a home session management function (H-SMF) entity located in a home public land mobile network (HPLMN) region in a communication system, the H-SMF entity comprising: a transceiver; and a controller coupled with the transceiver, the controller configured to: select a user plane function (UPF) entity for a user equipment (UE) located in a visited public land mobile network (VPLMN) region, transmit, to the selected UPF entity, a request message for a N4 session establishment, and as a response to the request message, receive, from the selected UPF entity, a response message including local domain name system (DNS) server information of the UE.

In accordance with an aspect of the disclosure, a user plane function (UPF) entity controlled by a home session management function (H-SMF) entity in a communication system, the UPF entity comprising: a transceiver; and a controller coupled with the transceiver, the controller configured to: receiving, from the H-SMF entity located in a home public land mobile network (HPLMN) region, a request message for a N4 session establishment; as a response to the request message, transmitting, to the H-SMF entity, a response message including local domain name system (DNS) server information of the UE; and transmitting, to a user equipment (UE) located in a visited public land mobile network (VPLMN) region, a protocol data unit (PDU) session.

According to an embodiment of the disclosure, a wireless communication can be performed efficiently. Especially, supporting traffic offloading of edge computing roaming service in wireless communication system can be performed efficiently.

### BRIEF DESCRIPTION OF THE DRAWINGS

The above and other aspects, features, and advantages of certain embodiments of the disclosure will be more apparent from the following detailed description taken in conjunction with the accompanying drawings, in which:

FIG. 1A illustrates a network structure of a 5G system according to an embodiment;

FIG. 1B illustrates a network structure of a 5G system according to an embodiment;

FIG. 2A illustrates a process of configuring a home routed (HR) home-session breakout (SBO) session according to an embodiment;

FIG. 2B illustrates a process of configuring an HR home-SBO session according to an embodiment;

FIG. 2C illustrates a process of configuring an HR home-SBO session according to an embodiment;

FIG. 3 illustrates a method of configuring EASDF or DNS information according to an embodiment;

FIG. 4A illustrates a process of configuring an HR home-SBO session according to an embodiment;

FIG. 4B illustrates a process of configuring an HR home-SBO session according to an embodiment;

FIG. 4C illustrates a process of configuring an HR home-SBO session according to an embodiment;

FIG. 5 illustrates a structure of a terminal according to an embodiment;

FIG. 6 illustrates a structure of an SMF according to an embodiment; and

FIG. 7 illustrates a structure of a network entity according to an embodiment.

### DETAILED DESCRIPTION

Hereinafter, embodiments of the disclosure are described in detail with reference to the accompanying drawings. It should be noted that in the drawings, the same or similar elements are preferably denoted by the same or similar reference numerals. Detailed descriptions of known functions or configurations that may make the subject matter of the disclosure unclear will be omitted for the sake of clarity and conciseness.

Terms described below are terms defined in consideration of functions in the disclosure, which may vary according to intentions or customs of users and providers. Therefore, the definition should be made based on the content throughout this specification.

Some components are exaggerated, omitted, or schematically illustrated in the accompanying drawings. The size of each component does not fully reflect the actual size. In each drawing, the same reference numerals are given to the same or corresponding components.

Embodiments of the disclosure enable a constitution of the disclosure to be complete, and are provided to fully inform the scope of the disclosure to those of ordinary skill in the art to which the disclosure pertains.

Like reference numerals refer to like components throughout the specification.

Terms indicating a network entity or a network function and entities of an edge computing system, and terms indicating messages and identification information used in the disclosure are provided for convenience of description. Accordingly, the disclosure is not limited to the terms described below, and other terms indicating an object having an equivalent technical meaning may be used.

Hereinafter, a BS is a subject performing resource allocation of a terminal, and may be at least one of a gNode B, an eNode B, a node B, (or xNode B (where x is an alphabet including g, e)), a radio access unit, a BS controller, a satellite, an airborne, or a node on a network. The UE may include a mobile station (MS), a vehicular, a satellite, an airborne, a cellular phone, a smart phone, a computer, or a multimedia system capable of performing a communication function. Herein, a downlink (DL) is a wireless transmission path of a signal transmitted from a BS to a UE, and an uplink (UL) is a wireless transmission path of a signal transmitted from a UE to a BS. Additionally, a sidelink (SL), which refers to a wireless transmission path of a signal transmitted from a UE to another UE, may exist.

A term identifying an access node or indicating network entities, network functions, messages, an interface between network objects, and various identification information is used for convenience of description. Accordingly, the disclosure is not limited to the terms described below, and other terms indicating an object having an equivalent technical meaning may be used.

Although the long term evolution (LTE), LTE-advanced (A) or 5G system may be described below as an example, the disclosure may also be applied to other communication systems with similar technical background or channel type. For example, embodiments of the disclosure may include 5G-A, NR-A, or 6G developed after 5G NR, and 5G may be a concept including existing LTE, LTE-A, and other similar services. The disclosure may be applied to other communication systems through some modifications without significantly departing from the scope of the disclosure at the discretion of a person with skilled technical knowledge.

3GPP, which controls cellular mobile communication standards, is standardizing a new core network structure, referred to as 5G core (5GC), to evolve from a 4G LTE system to a 5G system. The 5GC supports the following differentiated functions compared to an evolved packet core (EPC), which is for 4G.

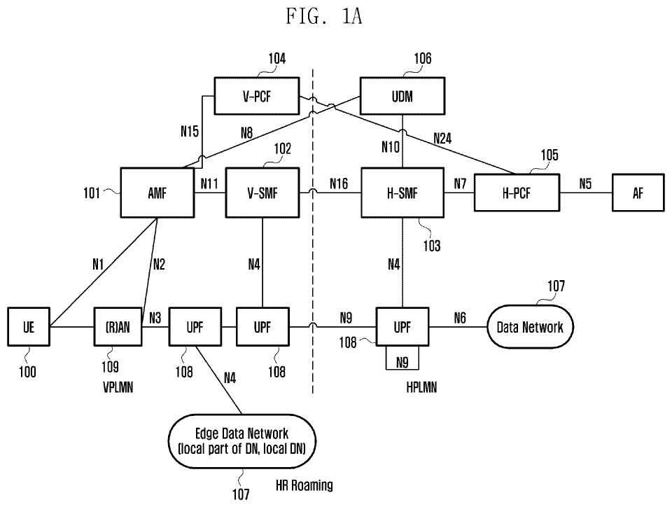

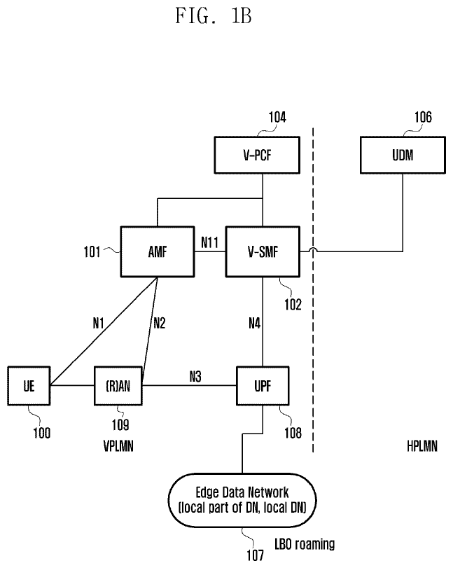

FIG. 1A illustrates a network structure of a 5G system according to an embodiment.

FIG. 1B illustrates a network structure of a 5G system according to an embodiment.

Referring to FIGS. 1A and 1B, a 5G system architecture supporting edge computing services may include various network functions (NFs), such as an access and mobility management function (AMF) 101, an SMF including a visited SMF (V-SMF) 102 or a home SMF (H-SMF) 103, a policy control function (PCF) including a visited PCF (V-PCF) 104 or a home PCF (H-PCF) 105, a unified data management (UDM) 106, a data network (DN) 107 or a local part of the DN 107 capable of performing local access to the DN, a UPF 108, a (radio) access network ((R) AN) 109, and a UE 100.

Each NF may support the following functions.

The AMF 101 may provide functions for access and mobility management in units of the UE 100. One UE 100 may be connected to one AMF 101.

The DN 107 indicates an operator service, Internet access, or 3rd party service which may transmit a DL protocol data unit (PDU) to the UPF 108 and may receive a PDU transmitted from the UPF 108 or from the UE 100.

The local part of the DN 107 may be a part of the DN 107 that is locally accessible to have a short data transmission path. Alternatively, the local part of the DN 107 may refer to a DN in which an edge application server supporting an edge computing service is disposed. The edge data network indicates a data network in which an edge computing server is disposed. The edge data network may be considered as a local part of a data network or a local data network (local part of DN or local DN).

The PCF may receive information on packet flows from an application server. The PCF may provide a function of determining policies such as mobility management or session management. For example, the PCF may support a unified policy framework so as to control a network operation. Alternatively, the PCF may provide policy rules so that control plane function(s) (e.g., AMF, SMF, and the like) may enforce the policy rules. Alternatively, the PCF may support front end implementation for accessing relevant subscription information for policy determination in a unified data repository (UDR).

The SMF may provide a session management function. When the UE has multiple sessions, each session may be managed by a different SMF.

The UDM 106 may store at least one of the user's subscription data or policy data.

The UPF may transmit a DL PDU received from the DN to the UE. In this case, the UPF may transmit the DL PDU to the UE via the (R)AN. The UPF may transmit an UL PDU received from the UE to the DN. In this case, the UPF may transmit the UL PDU to the DN via the (R)AN.

A UL classifier (ULCL) indicates a UPF having a function of classifying and transmitting an UL. A local UPF (L-UPF) may perform a termination role (PDU session anchor) of a session transmitted to the local part of the DN. In a wireless communication system using roaming, a UPF of a visited public land mobile network (VPLMN) may be disposed within the VPLMN. In this case, the UPF disposed within the VPLMN may perform UL data transmission or DL data transmission through the control of a visited session management function (V-SMF). A UPF of a home public land mobile network (HPLMN) may perform UL or DL data transmission through the control of a home session management function (H-SMF).

The edge application server discovery function (EASDF) processes domain name system queries transmitted by UEs according to rules provided by the SMF. For example, the EASDF may transmit DNS queries transmitted by the UE to the DNS server. Alternatively, the EASDF may receive a response from a domain name system (DNS). Alternatively, the EASDF may transmit related reporting to the SMF or may provide a DNS response received from the UE to the SMF.

To support edge computing services for a roaming UE, a local breakout (LBO) PDU session or an HR home-SBO PDU session may be used. A method of using the LBO PDU session or the HR home-SBO PDU session may be offloading specific service traffic from a VPLMN to an edge data network. Such a method is dependent on the VPLMN, and may be necessary for the HPLMN to provide offloading related information to the VPLMN. Herein, a roaming traffic offloading method that may be managed by the HPLMN, rather than a method dependent on the VPLMN, is proposed.

To this end, disclosed is a method in which a local UPF controlled by an H-SMF within a visited country determines or approves traffic offloading based on at least one of subscription data or policies.

Disclosed is a method in which the H-SMF selects or provides an EASDF or DNS server appropriate for traffic routed locally within a visited country.

Disclosed is a method of constituting UL or DL traffic routing through a local UPF controlled by the H-SMF between a roaming UE and an application server in a local part of a DN of a visited country. For example, disclosed is a method of supporting local routing application traffic of a roaming UE whose IP address is allocated by the HPLMN.

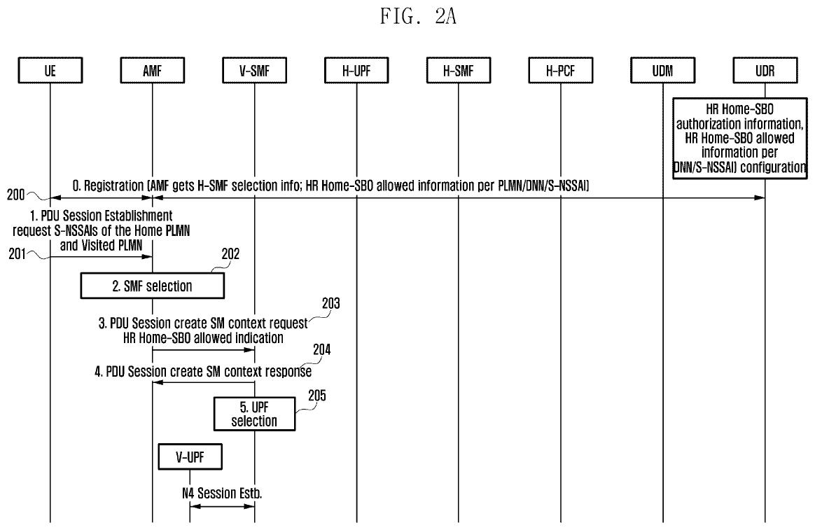

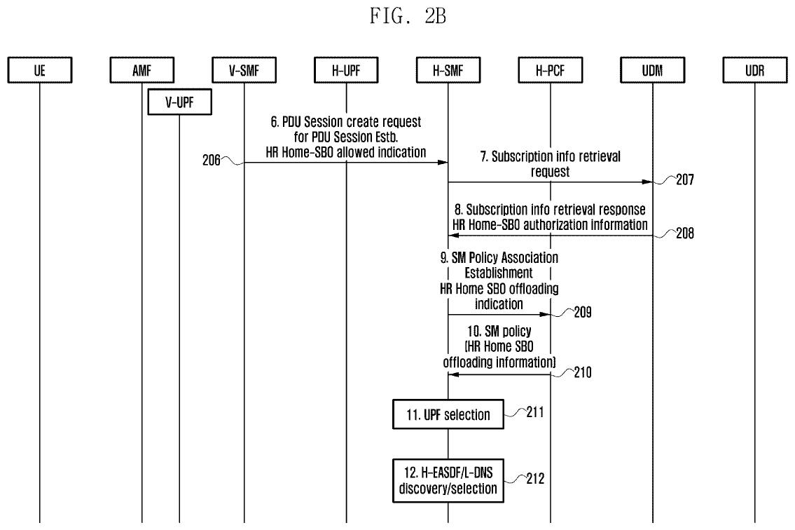

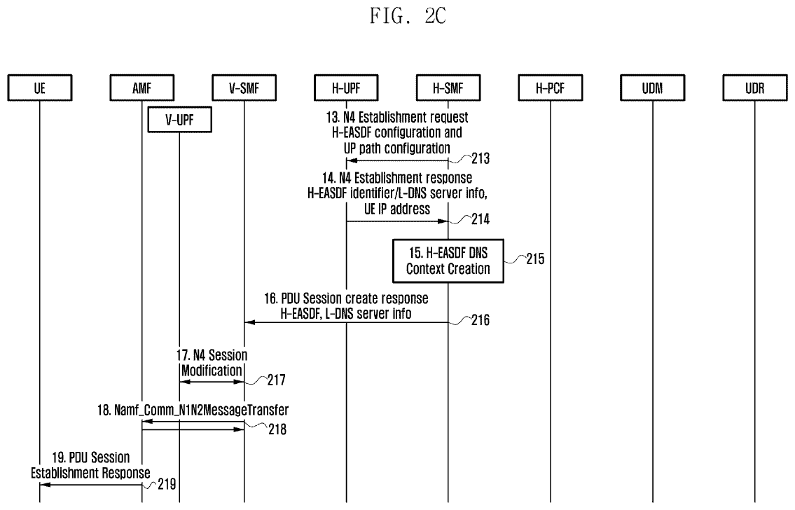

FIGS. 2A, 2B and 2C illustrate a process of configuring an HR home-SBO session according to an embodiment.

Referring to FIGS. 2A, 2B and 2C, in a UDM or UDR, at least one of HR home-SBO authorization information or HR home-SBO allowed information may be configured or stored for at least one information of a PLMN ID, DNN, or S-NSSAI.

In step 200, a UE may transmit a registration request to an AMF in a roaming VPLMN. The AMF may identify HR home-SBO allowed information (or HR-HSBO allowed information) from the UDM. The HR home-SBO allowed information may be subscriber information used for SMF selection (e.g., H-SMF selection information). The HR home-SBO allowed information indicates information on whether HR home-SBO is allowed for each specific public land mobile network (PLMN), data network name (DNN), and single-network slice selection assistance information (S-NSSAI) (e.g., HR home-SBO allowed information per PLMN, DNN or S-NSSAI).

In step 201, the UE may transmit a PDU session establishment request message to the AMF. The message may include at least one piece of information of a PDU session identifier (ID), DNN, or S-NSSAI. S-NSSAI information included in the message may include at least one of an S-NSSAI of an HPLMN or an S-NSSAI of a VPLMN. The PDU session establishment request message may include other information in addition to the above information.

In step 202, when the AMF receives HR home-SBO allowed information from the UDM, the AMF may select an SMF supporting HR home-SBO (e.g., at least one of a V-SMF or an H-SMF). If HR home-SBO is allowed for at least one of a PDU session, DNN, or S-NSSAI (e.g., when HR home-SBO allowed information is received from the UDM, if HR home-SBO is allowed according to an operator policy according to roaming agreement or service level agreement configured in the AMF), when the AMF selects an H-SMF, the AMF may select an SMF that may cover up to a region of the VPLMN (or up to a region where the UE is currently roaming). When the AMF selects an SMF, the AMF may select an SMF that may cover a region where the UE is currently roaming.

In step 203, the AMF may transmit a request message for a session management (SM) context (e.g., PDU session create SM context request) to a V-SMF. The SM context may be for creating a PDU session. If HR home-SBO is allowed for at least one of the corresponding PDU session, DNN, or S-NSSAI (e.g., when HR home-SBO allowed information is received from the UDM, or if HR home-SBO is allowed according to an operator policy according to roaming agreement or service level agreement configured in the AMF), the AMF may transmit an HR home-SBO allowed indication to the V-SMF. The HR home-SBO allowed indication may be included in the SM contest request and transmitted. Alternatively, the SM context request may be transmitted in relation to the HR-SBO allowed indication.

In step 204, the V-SMF may transmit a response message to the AMF. When the V-SMF receives the HR home-SBO allowed indication, the V-SMF may determine whether it may perform a PDU session establishment procedure supporting HR home-SBO for at least one of the corresponding PDU session, DNN, or S-NSSAI. If the V-SMF may perform the PDU session establishment procedure, the V-SMF may include an SM context ID in the response message and transmit the response message to the AMF.

In step 205, the V-SMF may select a V-UPF capable of supporting HR home-SBO and configure the selected V-UPF. The V-SMF may select a V-UPF capable of being connected to an H-UPF determined for HR home-SBO to support HR home-SBO. The V-SMF may select a UPF supporting an inter PLMN user plane security (IPUPS) function to support HR home-SBO. Alternatively, the V-SMF may select a UPF capable of being connected to a specific data center (e.g., a data center in which a UPF capable of supporting HR home-SBO is hosted). Alternatively, the V-SMF may perform an N4 session establishment procedure for the V-UPF to perform a configuration for the V-UPF.

In step 206, the V-SMF may transmit a request message for creating a PDU session (e.g., PDU session create request) to the H-SMF. The request message may include an HR home-SBO allowed indication. Alternatively, the request message may be related to the HR home-SBO allowed indication. The V-SMF may transmit at least one of a UE ID, DNN, S-NSSAI, V-SMF SM context ID, PDU session ID, V-SMF ID, V-CN-Tunnel information, or domain name system (DNS) security information (DNS security information of a specific DNS server in the VPLMN or V-EASDF DNS security information).

In step 207, the H-SMF may transmit a message requesting subscriber information (e.g., subscription information retrieval request) to the UDM. In this case, the H-SMF may provide at least one of an LMN ID, DNN, S-NSSAI, or subscription permanent ID (SUPI) to the UDM. The H-SMF may acquire subscription data corresponding to at least one of a PLMN ID, VPLMN ID, serving PLMN ID, DNN, or S-NSSAI from the UDM to perform HR home-SBO authorization.

In step 208, the UDM may transmit a subscriber information retrieval response message (e.g., subscription information retrieval response) in response to the subscriber information request message. The UDM may transmit HR home-SBO authorization information to the H-SMF. The HR home-SBO authorization information may correspond to at least one of a PLMN ID, DNN, or S-NSSAI, The HR home-SBO authorization information may include information on whether HR home-SBO is allowed for a specific UE or a specific PDU session. The H-SMF may identify whether HR home-SBO authorization is allowed for at least one of the corresponding UE, the corresponding PDU session, or the corresponding VPLMN.

Alternatively, HR home-SBO authorization information may not be configured in the UDM. The H-SMF may perform an authorization procedure on whether HR home-SBO authorization is allowed for at least one of a specific UE, specific PDU session, or specific PLMN based on information such as operator policies configured in the SMF.

In step 209, the H-SMF may request establishment associated with an SM policy (e.g., SM policy association establishment) to an H-PCF. The H-SMF may request HR home-SBO offloading information to the H-PCF. The HR home-SBO offloading information may be identified through an SM policy association establishment request.

In step 210, the H-SMF may identify HR home-SBO offloading information from the H-PCF. The HR home-SBO offloading information may include information that may be used for identifying and detecting an HR home-SBO target service such as an FQDN, IP address, or application ID.

In step 211, the H-SMF may select a UPF capable of performing HR home-SBO in consideration of at least one of a UE location, UPF location, PLMN ID, serving network ID, mobile country code, serving PLMN ID, UPF locality information, or UE location information. The selected UPF may be an H-UPF.

In step 212, the H-SMF may perform at least one of discovery or selection for at least one of an H-EASDF or L-DNS in consideration of at least one of an S-NSSAI, DNN, VPLMN ID (or serving PLMN ID), N6 IP address of an EASDF, N6 IP address of the PSA UPF, UE location information, EASDF location information, EASDF locality information, or local DNS server location information. The H-SMF may be configured (e.g., locally configured) with local DNS server information (e.g., address or DNS security information) for at least one of an UPF, UPF group, specific VPLMN ID, or serving PLMN ID. The H-SMF may select a DNS server for supporting HR home-SBO for the roaming UE among configured DNS server information in consideration of at least one of a VPLMN ID, serving PLMN ID, N6 IP address of an EASDE, N6 IP address of the PSA UPF, or UE location information.

Steps 211 and 212 may be performed simultaneously, and either one of the two steps may be performed first according to at least one of an H-SMF implementation method, operator policy, or specific condition. When there is no available EASDF information or DNS server information according to the local configuration, the H-SMF may identify the corresponding information from the UPF. For example, the H-SMF may identify the information from the UPF while performing step 213 or 214 or may acquire EASDF information or DNS server information from the H-UPF through node level N4 message transmission and reception between the H-UPF and the H-SMF.

In step 213, the H-SMF may perform a configuration for the H-UPF. The H-SMF may transmit an N4 session establishment request message (e.g., N4 establishment request) to the H-UPF. The N4 session establishment request message may include at least one of a DNS establishment information request indicator or a remote domain UP-related configuration information request indicator. The remote domain UP-related configuration information may include DNS establishment information, maximum transmission unit (MTU) information, and the like. The MTU information indicates the magnitude of a maximum protocol data unit (datagram or packet) that may be transmitted on a path on a user plane connected to the H-UPF. For example, the MTU information indicates the maximum magnitude of one IP datagram that may be transmitted through a path between the H-UPF and the V-UPF. The H-SMF may perform a configuration for the H-UPF in consideration of HR home-SBO offloading information. For example, the H-SMF may configure at least one of packet detection, forward and action rules, N6 routing information, H-EASDF configuration information, or UP path configuration information for specific service data traffic to the UPF.

In step 214, the H-UPF may transmit an N4 establishment response in response to the N4 session establishment request message. The message may include at least one of H-EASDF information (e.g., H-EASDF address information, H-EASDF ID, or H-EASDF related DNS security information), local DNS information (e.g., DNS address information, L-DNS server information, or DNS security information), MTU information, or UE IP address. Address information that may be included in the H-EASDF or local DNS information may include an address transmitted to the UE or address information that may be identified on an N6 interface in a core network.

In step 215, the H-SMF may select an H-EASDF or local DNS server to use for the corresponding PDU session in consideration of the H-EASDF or local DNS information. The H-EASDF or local DNS information may be information selected by the H-SMF or information provided by the H-UPF. The H-SMF may create a DNS context for the H-EASDF in consideration of the HR home-SBO offloading information. When the H-SMF selects a local DNS server, the H-SMF may configure a local DNS through the operations, administrations, and maintenance (OAM).

In step 216, the H-SMF may transmit a PDU session establishment request response message to the V-SMF in response to the PDU session establishment request. The PDU session establishment request response message may include at least one of information on an H-EASDF, local DNS server (e.g., at least one of an ID address or DNS security information), H-CN tunnel information, or MTU. The H-CN tunnel information may be expressed as at least one of core network tunnel information related to the H-UPF, or core network tunnel information for the H-UPF available in a roaming region.

In step 217, the V-SMF may transmit an N4 session modification message (e.g., N4 session modification) to the V-UPF. In step 217, the V-UPF may transmit an N4 session modification message (e.g., N4 session modification) to the V-SMF. The N4 session modification message may occur simultaneously in both directions. Alternatively, according to the situation, the V-SMF may transmit first an N4 session modification message and then the V-UPF may transmit an N4 session modification message, or the V-UPF may transmit first an N4 session modification message and then the V-SMF may transmit an N4 session modification message. Alternatively, after any one transmits an N4 session modification message, the other one may not transmit an N4 session modification message.

In step 218, the V-SMF may transmit an N1N2 message (e.g., Namf_Comm_N1N2MessageTransfer) to the AMF. The message may include at least one of information on an H-EASDF or a local DNS server (e.g., at least one of an ID address or DNS security information) or an MTU. Further in step 218, the AMF may transmit an N1N2 message (e.g., Namf_Comm_N1N2MessageTransfer) to the V-SMF.

In step 219, the AMF may transmit a PDU session establishment response message (e.g., PDU session establishment response) to the UE in response to the PDU session establishment request message. The message may include information on an H-EASDF, local DNS server (ID address and DNS security information), or MTU. The UE may transmit a DNS query message using the received H-EASDF or local DNS server information. The UE may determine an IP packet payload size in consideration of the received MTU information.

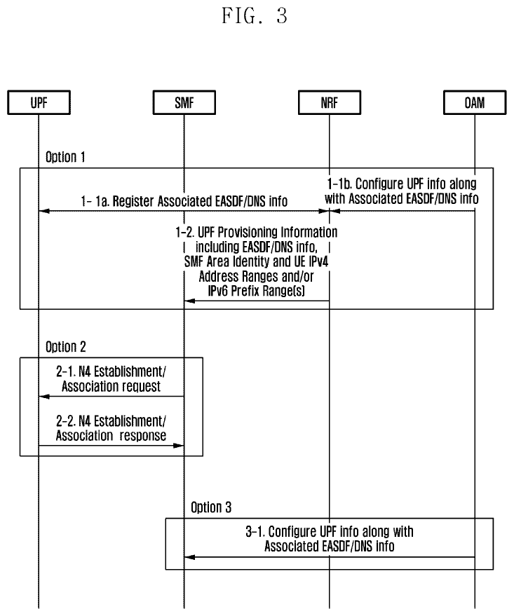

FIG. 3 illustrates a method of configuring MTU information, EASDF information, or DNS server information according to an embodiment.

Referring to FIG. 3, provided are three options of providing at least one of EASDF information, DNS server information, or MTU information to the SMF are proposed. The SMF may identify MTU information, EASDF information, or DNS server information related to the UPF through at least one of the following three options. EASDF information, DNS server information, and MTU information may be included in remote domain UP-related configuration information and provided to the SMF.

Option 1: Method of providing at least one of EASDF information or DNS server information to the SMF through an NRF

In step 1-1a, the UPF may register EASDF information or DNS server information related to the UPF to the NRF. In this case, MTU information, EASF information, or DNS server information may be registered corresponding to at least one of a UPF ID, a UPF group, or an IP range managed in the UPF. The EASDF information or the DNS server information may include at least one of address information or DNS security information. The address information may include at least one of an address transmitted to the UE to be used for transmitting a DNS message or address information used within a core network. When there is at least one of MTU information, EASDF information, or DNS server information, configured from operations, administrations, and maintenance (OAM), the UPF may register at least one of the MTU information, EASDF information, or DNS server information to the network repository function (NRF).

In step 1-1b, the NRF may receive at least one of MTU information, EASDF information, or DNS server information related to at least one of a UPF or a UPF group from the OAM. At least one of MTU information, EASDF information, or DNS server information may be received along with at least one of an MCC, PLMN ID, VPLMN ID, or UPF location information. An operation of receiving at least one of MTU information, EASDF information, or DNS server information may be performed through an operation in which the NRF receives UPF provisioning information from the OAM. When the NRF receives at least one of an MCC, PLMN ID, VPLMN ID, or serving PLMN ID together with the DNS server information, the DNS server may be associated with at least one of a specific country or a specific PLMN ID region. Alternatively, the DNS server may be associated with the UPF disposed in at least one of a specific country or a specific PLMN ID.

The NRF may receive a registration request message from the EASDF. In this case, the NRF may receive or identify EASDF information related to the UPF or UPF group. The registration request message may include at least one of a PLMN ID, UPF information, MCC, EASDF location information (e.g., locality), EASDF address information, or DNS security information used in the EASDF.

In step 1-2, the NRF may provide at least one of MTU information, EASDF information, or DNS server information to the SMF. The MTU information, EASDF information, or DNS server information may correspond to the UPF or the UPF group. The NRF may transmit UPF provisioning information to the SMF. The UPF provisioning information may include at least one of MTU information, EASDF information, DNS server information, MCC, PLMN ID, VPLMN ID, or serving PLMN ID. When at least one of the MCC, PLMN ID, VPLMN ID, or serving PLMN ID is received along with at least one of MTU information, EASDF information, or DNS server information, at least one of the corresponding MTU information, EASDF information, or DNS server information may be associated with at least one of a specific country or a specific PLMN ID region. Alternatively, when at least one of the MCC, PLMN ID, VPLMN ID, or serving PLMN ID is received along with at least one of MTU information, EASDF information, or DNS server information, at least one of the MTU information, EASDF information, or DNS server information may be associated with a UPF disposed in at least one of a specific country or a specific PLMN ID.

Option 2: Method of providing at least one of MTU information, EASDF information, or DNS server information to the SMF through the UPF

When the SMF fails to acquire at least one of MTU information, EASDF information, or DNS server information according to Option 1, the SMF may perform an operation of Option 2. Alternatively, the SMF may perform directly an operation of Option 2 without performing the operation of Option 1. Alternatively, both operations may be performed simultaneously. Alternatively, even if at least one of MTU information, EASDF information, or DNS server information was acquired according to Option 1, an operation of Option 2 may be performed.

In step 2-1, the SMF may transmit a remote domain UP-related configuration information request or a DNS server information request to the UPF. The remote domain UP-related configuration information request or the DNS server information request may be performed, for example, through at least one of an N4 session establishment request or an N4 session modification request. The remote domain UP-related configuration information request or the DNS server information request may be transmitted during PDU session establishment or modification. The remote domain UP-related configuration information request or the DNS server information request may include at least one of a remote domain UP-related configuration information request indicator, an MTU information request indicator, an EASDF information request indicator, or a DNS server information request indicator and be transmitted. The SMF may perform the remote domain UP-related configuration information request or the DNS server request for a specific PDU session (e.g., a session corresponding to at least one of a specific DNN or S-NSSAI, or at least one of sessions in which HR home-SBO is allowed).

In step 2-2, the UPF may transmit a response message to the SMF in response to the remote domain UP-related configuration information request or the DNS server information request. The response message may include at least one of MTU information, EASDF information, DNS server information, MCC, PLMN ID, VPLMN ID, serving PLMN ID, DNN, or S-NSSAI.

Alternatively, the SMF may receive at least one of MTU information, EASDF information, or DNS server information from the UPF through an N4 node level procedure. For example, the SMF may transmit an indicator requesting at least one of MTU information, EASDF information, or DNS server information in an N4 associated request message or an indicator requesting remote domain UP-related configuration information to the UPF. In response to the N4 associated request message, the UPF may transmit at least one of MTU information, EASDF information, or DNS server information to the SMF. The SMF may map the information with at least one of UPF information or UPF group information to which the UPF belongs to store or manage at least one of the MTU information, EASDF information, or DNS server information. When the SMF receives at least one of an MCC, PLMN ID, VPLMN ID, or serving PLMN ID together with at least one of MTU information, EASDF information, or DNS server information, at least one of the MTU information, EASDF information, or DNS server information may be associated with at least one of a specific country or a specific PLMN ID region. Alternatively, when the SMF receives at least one of an MCC, PLMN ID, VPLMN ID, or serving PLMN ID together with at least one of MTU information, EASDF information, or DNS server information, at least one of the EASDF information or DNS server information may be associated with a UPF disposed in at least one of a specific country or a specific PLMN ID.

When an HR home-SBO operation is required or when an UPF is selected for the HR home-SBO session, the SMF may use at least one of MTU information, EASDF information, or DNS server information when creating a PDU session. Alternatively, the SMF may provide at least one of MTU information, EASDF information, or DNS server information to the UE through a process of creating or modifying a PDU session.

Option 3: Method of providing at least one of MTU information, EASDF information, or DNS server information to the SMF through the OAM

In step 3-1, the SMF may receive a configuration of at least one of MTU information, EASDF information, or DNS server information associated with the corresponding UPF from the OAM. At least one of MTU information, EASDF information, or DNS server information may be configured together with UPF information. Alternatively, at least one of the MTU information, EASDF information, or DNS server information may be configured together with at least one of an MCC, PLMN ID, VPLMN ID, or serving PLMN ID from the OAM. When an HR home-SBO operation is required or when an UPF is selected for an HR home-SBO session, the SMF may use at least one of the configured MTU information, EASDF information, or DNS server information when creating a PDU session. Alternatively, the SMF may provide at least one of EASDF information or DNS server information to the UE through a process of creating or modifying a PDU session.

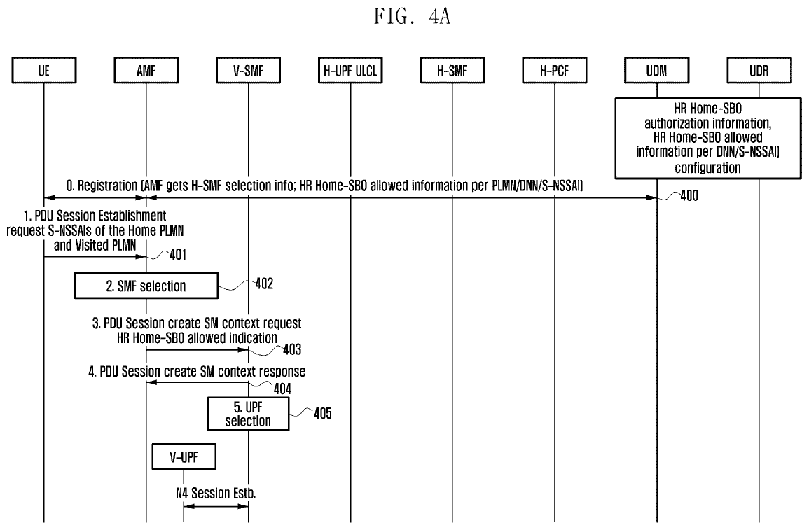

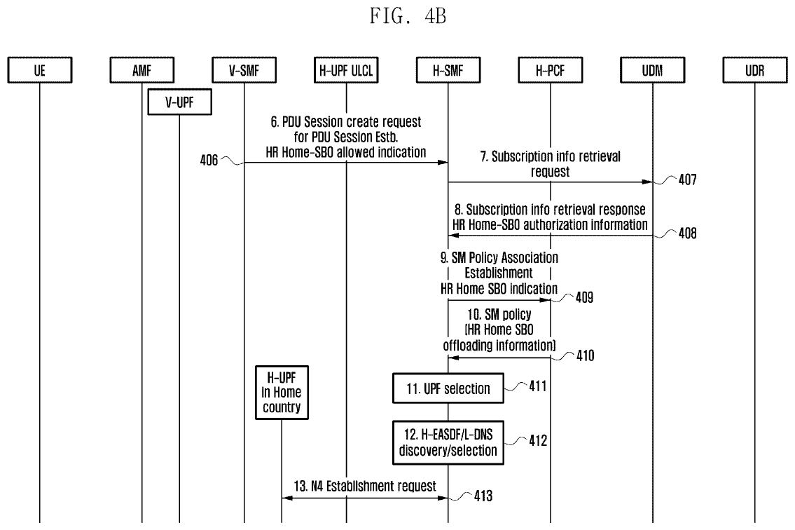

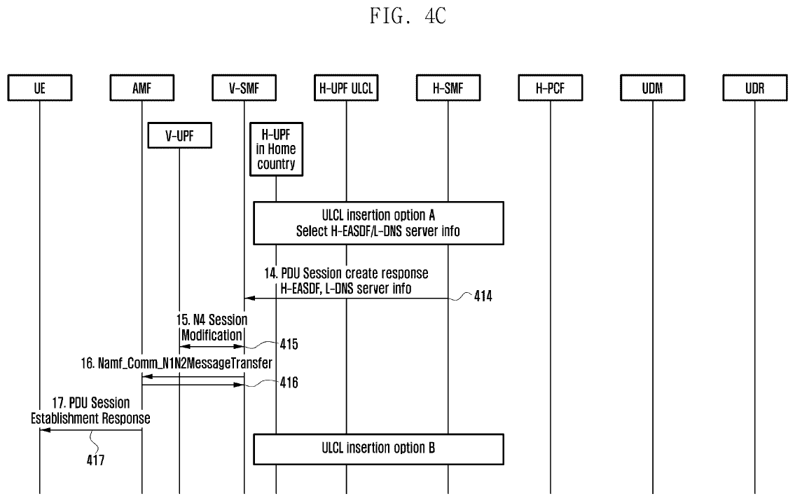

FIGS. 4A, 4B and 4C illustrate a process of determining an HR home-SBO session according to an embodiment.

Referring to FIGS. 4A, 4B and 4C, in a UDM or UDR, at least one of home routed home session breakout (HR home-SBO) authorization information or HR home-SBO allowed information may be configured or stored for at least one information of a PLMN ID, DNN, or S-NSSAI.

In step 400, a user equipment (hereinafter, a UE) may transmit a registration request to an AMF in a roaming VPLMN. The AMF may identify HR home-SBO allowed information (or HR-HSBO allowed information) from the UDM. The HR home-SBO allowed information may be subscriber information used for SMF selection (e.g., H-SMF selection information). The HR home-SBO allowed information indicates information on whether HR home-SBO is allowed for each specific public land mobile network (PLMN), data network name (DNN), and single-network slice selection assistance information (S-NSSAI) (e.g., HR home-SBO allowed information per PLMN, DNN, or S-NSSAI).

In step 401, the UE may transmit a PDU session establishment request message to the AMF. The message may include at least one information of a PDU session ID, DNN, or S-NSSAL S-NSSAI information included in the message may include at least one of an S-NSSAI of an HPLMN or an S-NSSAI of a VPLMN. The PDU session establishment request message may include other information in addition to the above information.

In step 402, when the AMF receives HR home-SBO allowed information from the UDM, the AMF may select an SMF supporting HR home-SBO (e.g., at least one of a V-SMF or an H-SMF). If HR home-SBO is allowed for at least one of a PDU session, DNN, or S-NSSAI (e.g., when HR home-SBO allowed information is received from the UDM, if HR home-SBO is allowed according to an operator policy according to roaming agreement or service level agreement configured in the AMF), when the AMF selects an H-SMF, the AMF may select an SMF that may cover up to a region of the VPLMN (or up to a region where the UE is currently roaming). When the AMF selects an SMF, the AMF may select an SMF that may cover a region where the UE is currently roaming.

In step 403, the AMF may transmit a request message for a session management (SM) context (e.g., PDU session create SM context request) to the V-SMF. The SM context may be for creating a PDU session. If HR home-SBO is allowed for at least one of the corresponding PDU session, DNN, or S-NSSAI (e.g., when HR home-SBO allowed information is received from the UDM or if HR home-SBO is allowed according to an operator policy according to roaming agreement or service level agreement configured in the AMF), the AMF may transmit an HR home-SBO allowed indication to the V-SMF. The HR-Home-SBO allowed indication may be included in an SM contest request and transmitted. Alternatively, the SM context request may be transmitted in relation to the HR-SBO allowed indication.

In step 404, the V-SMF may transmit a response message to the AMF. When the V-SMF receives an HR home-SBO allowed indication, the V-SMF may determine whether it may perform a PDU session establishment procedure supporting HR home-SBO for at least one of the corresponding PDU session, DNN, and S-NSSAI. If the V-SMF may perform the PDU session establishment procedure, the V-SMF may include an SM context ID in the response message and transmit the response message to the AMF.

In step 405, the V-SMF may select a V-UPF capable of supporting HR home-SBO and configure the selected V-UPF. The V-SMF may select a V-UPF capable of being connected to an H-UPF determined for HR home-SBO to support HR home-SBO. The V-SMF may select a UPF supporting an inter PLMN user plane security (IPUPS) function to support HR home-SBO, Alternatively, the V-SMF may select a UPF capable of being connected to a specific data center (e.g., a data center in which a UPF capable of supporting HR home-SBO is hosted). Alternatively, the V-SMF may perform an N4 session establishment procedure for the V-UPF to perform a configuration for the V-UPF.

In step 406, the V-SMF may transmit a request message (e.g., PDU session create request) for creating a PDU session to the H-SMF. The request message may include an HR home-SBO allowed indication. Alternatively, the request message may be related to the HR home-SBO allowed indication. The V-SMF may transmit at least one of a UE ID, DNN, S-NSSAI, V-SMF SM context ID, PDU session ID, V-SMF ID, V-CN-tunnel information, or domain name system (DNS) security information (DNS security information of a specific DNS server in the VPLMN or V-EASDF DNS security information).

In step 407, the H-SMF may transmit a message requesting subscriber information (e.g., subscription information retrieval request) to the UDM. In this case, the H-SMF may provide at least one of an LMN ID, DNN, S-NSSAI, or subscription permanent ID (SUPI) to the UDM. The H-SMF may acquire subscription data corresponding to at least one of a PLMN ID, VPLMN ID, serving PLMN ID, DNN, or S-NSSAI from the UDM to perform HR home-SBO authorization.

In step 408, the UDM may transmit a subscriber information retrieval response message (e.g., subscription information retrieval response) in response to the subscriber information request message. The UDM may transmit HR home-SBO authorization information to the H-SMF. The HR home-SBO authorization information may correspond to at least one of a PLMN ID, DNN, or S-NSSAI. The HR home-SBO authorization information may include information on whether HR home-SBO is allowed for a specific UE or a specific PDU session. The H-SMF may identify whether HR home-SBO authorization is allowed for at least one of the corresponding UE, the corresponding PDU session, or the corresponding VPLMN.

Alternatively, HR home-SBO authorization information may not be configured in the UDM. The H-SMF may perform an authorization procedure on whether HR home-SBO authorization is allowed for at least one of a specific UE, specific PDU session, or specific PLMN based on information such as operator policies configured in the SMF.

In step 409, the H-SMF may request establishment associated with an SM policy (e.g., SM policy association establishment) to an H-PCF. The H-SMF may request HR home-SBO offloading information to the H-PCF. The corresponding HR home-SBO offloading information may be identified through an SM policy association establishment request,

In step 410, the H-SMF may identify HR home-SBO offloading information from the H-PCF. The HR home-SBO offloading information may include information that may be used for identifying and detecting an HR home-SBO target service such as an FQDN, IP address, or application ID.

In step 411, the H-SMF may select a UPF capable of performing HR home-SBO in consideration of at least one of a UE location, UPF location, PLMN ID, serving network ID, mobile country code, serving PLMN ID, UPF locality information, or UE location information. The selected UPF may be an H-UPF.

In step 412, the H-SMF may perform at least one of discovery or selection for at least one of an H-EASDF or an L-DNS in consideration of at least one of an S-NSSAI, DNN, VPLMN ID (or serving PLMN ID), N6 IP address of an EASDF, N6 IP address of the PSA UPF, UE location information, EASDF location information, EASDF locality information, or local DNS server location information. The H-SMF may be configured (e.g., locally configured) with local DNS server information (e.g., address or DNS security information) for at least one of an UPF, UPF group, specific VPLMN ID, or serving PLMN ID. The H-SMF may select a DNS server for supporting HR home-SBO for the roaming UE among configured DNS server information in consideration of at least one of a VPLMN ID, serving PLMN ID, N6 IP address of an EASDF, N6 IP address of the PSA UPF, or UE location information.

Steps 411 and 412 may be performed simultaneously, and either one of the two steps may be performed first according to at least one of an H-SMF implementation method, operator policy, or specific condition. When there is no available EASDF information or DNS server information according to a local configuration, the H-SMF may identify the corresponding information from the UPF. For example, the H-SMF may identify the information from the UPF while performing step 413 or 414 or may acquire EASDF information or DNS server information from the H-UPF through node level N4 message transmission and reception between the H-UPF and the H-SMF.

In step 413, the H-SMF may perform a configuration for the H-UPF. The H-SMF may transmit an N4 session establishment request message (e.g., N4 establishment request) to the H-UPF. The N4 session establishment request message may include at least one of a DNS establishment information request indicator or a remote domain UP-related configuration information request indicator. The remote domain UP-related configuration information may include DNS establishment information, MTU information, and the like. The MTU information indicates the magnitude of a maximum protocol data unit (datagram or packet) that may be transmitted on a path on a user plane connected to the H-UPF. For example, the MTU information indicates the maximum magnitude of one IP datagram that may be transmitted through a path between the H-UPF and the V-UPF. The H-SMF may perform a configuration for the H-UPF in consideration of HR home-SBO offloading information. For example, the H-SMF may configure at least one of packet detection, forward and action rules, N6 routing information, H-EASDF configuration information, or UP path configuration information for specific service data traffic to the UPF.

The H-SMF may select an H-UPF supporting at least one of ULCL or IPUPS functions disposed in an area of the VPLMN. The H-SMF may perform ULCL insertion (Option A). The H-SMF may discover or select at least one of an H-EASDF or an L-DNS when HR home-SBO authorization is performed (e.g., when HR home-SBO authorization is received). In this case, the H-SMF may consider at least one of an S-NSSAI, DNN, VPLMN ID, N6 IP address of an EASDF, or N6 IP address of the PSA UPF. When the H-SMF selects an H-EASDF, the H-SMF may create a DNS context in the H-EASDF immediately after selection, or create or modify a DNS context when a DNS query occurs later.

In step 414, the H-SMF may transmit a PDU session establishment request response message to the V-SMF in response to the PDU session establishment request. The PDU session establishment request response message may include at least one of information on an H-EASDF, local DNS server (e.g., at least one of an ID address or DNS security information), H-CN tunnel information, or MTU. The H-CN tunnel information may be expressed as at least one of core network tunnel information related to the H-UPF, or core network tunnel information for an H-UPF available in a roaming region.

In step 415, the V-UPF may transmit an N4 session modification message (e.g., N4 session modification) to the V-UPF. In step 17, the V-UPF may transmit an N4 session modification message (e.g., N4 session modification) to the V-SMF. The N4 session modification message may occur simultaneously in both directions. Alternatively, according to the situation, the V-SMF may transmit first an N4 session modification message and then the V-UPF may transmit an N4 session modification message, or the V-UPF may transmit first an N4 session modification message and then the V-SMF may transmit an N4 session modification message. Alternatively, after any one transmits an N4 session modification message, the other one may not transmit an N4 session modification message.

In step 416, the V-SMF may (e.g., transmit an N1N2 message Namf_Comm_N1N2MessageTransfer) to the AMF. The message may include at least one of information on an H-EASDF, local DNS server (e.g., at least one of an ID address or DNS security information), or MTU. The AMF may transmit an N1N2 message (e.g., Namf_Comm_N1N2MessageTransfer) to the V-SMF.

In step 417, the AMF may transmit a PDU session establishment response message (e.g., PDU session establishment response) to the UE in response to the PDU session establishment request message. The message may include information on an H-EASDF, local DNS server (ID address and DNS security information), or MTU. The UE may transmit a DNS query message using the received H-EASDF or local DNS server information. The UE may determine an IP packet payload size in consideration of the received MTU information.

The H-SMF may select an H-UPF supporting at least one of ULCL or IPUPS functions disposed in a VPLMN area. The H-SMF may perform ULCL insertion (Option B). H-UPF selection and ULCL insertion may be performed in a step of Option A or B.

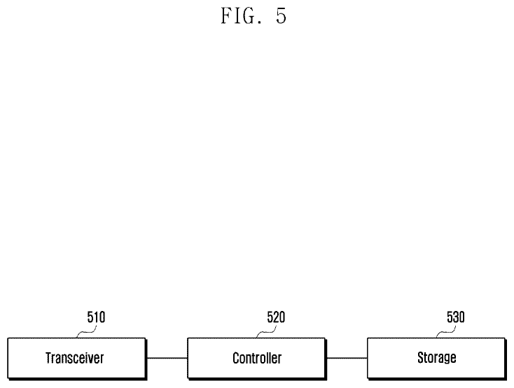

FIG. 5 illustrates a structure of a UE according to an embodiment.

Referring to FIG. 5, the UE may include a transceiver 510, a controller 520, and a storage 530. In the disclosure, the controller may be defined to a circuit, an application-specific integrated circuit, or at least one processor.

The transceiver may transmit and receive signals to and from other network entities. The transceiver may, for example, receive system information from the BS and receive synchronization signals or reference signals.

The controller may control the overall operation of the UE according to an embodiment of the disclosure. For example, the controller may control the overall function of the UE according to an embodiment of the disclosure.

The storage may store at least one of information transmitted and received through the transceiver or information generated through the controller.

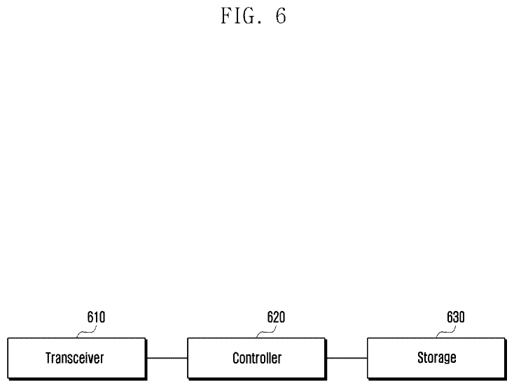

FIG. 6 illustrates a structure of an SMF according to an embodiment.

Here, the SMF may be at least one of a V-SMF or H-SMF.

A transceiver 610 may transmit and receive signals to and from other network entities.

A controller 620 may control the overall operation of network entities according to an embodiment of the disclosure. For example, the controller may operate to control the operation according to the message flow diagram described herein.

A storage 630 may store at least one of information transmitted and received through the transceiver or information generated through the controller,

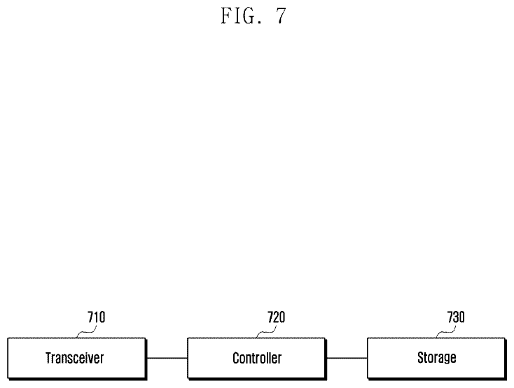

FIG. 7 illustrates a structure of an SMF according to an embodiment.

Network entities may be composed of an AMF, UPF (e.g., H-UPF), PCF, UDM, or UDF.

A transceiver 710 may transmit and receive signals to and from other network entities.

A controller 720 may control the overall operation of network entities according to an embodiment of the disclosure. For example, the controller may operate to control the operation according to the message flow diagram described herein.

A storage 730 may store at least one of information transmitted and received through the transceiver or information generated through the controller.

The operations of the network entity or the UE described above may be realized by providing a memory device storing the corresponding program code in an arbitrary component in the network entity or the UE device. That is, a controller of the network entity or the UE device may execute the above-described operations by reading and executing the program code stored in the memory device by a processor or a central processing unit (CPU).

Various components and modules of the network entity, the BS, or the UE device described in this specification may be operated using a hardware circuit such as a combination of a complementary metal oxide semiconductor-based logic circuit, firmware, software, and/or hardware and firmware and/or software inserted into a machine readable medium. For example, various electrical structures and methods may be implemented using electrical circuits such as transistors, logic gates, and application specific integrated circuits.

Each block of message flow diagrams and combinations of the message flow diagrams may be performed by computer program instructions. Because these computer program instructions may be mounted in a processor of a general purpose computer, special purpose computer, or other programmable data processing equipment, the instructions performed by a processor of a computer or other programmable data processing equipment generate a means that performs functions described in the message flow diagram block(s). Since these computer program instructions may be stored in a computer usable or computer readable memory that may direct a computer or other programmable data processing equipment to implement a function in a particular manner, the instructions stored in the computer usable or computer readable memory may produce a production article containing instructions for performing the function described in the message flow diagram block(s). Because the computer program instructions may be mounted on a computer or other programmable data processing equipment, a series of operation steps are performed on the computer or other programmable data processing equipment to generate a computer-executable process; thus, instructions for performing the computer or other programmable data processing equipment may provide steps for performing functions described in the message flow diagram block(s).

Each block may represent a portion of a module, a segment, or a code including one or more executable instructions for executing a specified logical function(s). Further, it should be noted that in some alternative implementations, functions recited in the blocks may occur out of order. For example, two blocks illustrated one after another may in fact be performed substantially simultaneously, or the blocks may be sometimes performed in the reverse order according to the corresponding function.

In this case, the term unit used in this embodiment means software or hardware components such as field programmable gate array (FPGA) or application specific integrated circuit (ASIC), and unit performs certain roles. However, the unit is not limited to software or hardware. unit may be constituted to reside in an addressable storage medium or may be constituted to reproduce one or more processors. Therefore, a unit includes components such as software components, object-oriented software components, class components, and task components, processes, functions, properties, procedures, subroutines, segments of program code, drivers, firmware, microcode, circuit, data, databases, data structures, tables, arrays, and variables. Functions provided in the components and units may be combined into a smaller number of components and units or may be further separated into additional components and units. Components and units may be implemented to reproduce one or more CPUs in a device or secure multimedia card. A unit may include one or more processors.

Methods according to the embodiments described in the claims or specifications of the disclosure may be implemented in the form of hardware, software, or a combination of hardware and software.

When implemented in software, a computer readable storage medium storing one or more programs (software modules) may be provided. One or more programs stored in the computer readable storage medium are configured for execution by one or more processors in an electronic device. The one or more programs may include instructions for causing the electronic device to execute methods according to embodiments described in claims or specification of the disclosure.

Such programs (software modules, software) may be stored in a random access memory, a non-volatile memory including a flash memory, a read only memory (ROM), an electrically erasable programmable ROM (EEPROM), a magnetic disc storage device, a compact disc-ROM (CD-ROM), digital versatile discs (DVDs), another form of optical storage device, or a magnetic cassette. Alternatively, the programs may be stored in a memory composed of a combination of some or all thereof. Each constitution memory may be included in the plural.

The program may be stored in an attachable storage device that may access through a communication network such as the Internet, Intranet, local area network (LAN), wide LAN (WLAN), or storage area network (SAN), or a communication network composed of a combination thereof. Such a storage device may access a device implementing an embodiment of the disclosure through an external port. A separate storage device on the communication network may access the device implementing the embodiment of the disclosure.

Components included in the disclosure have been expressed in the singular or the plural according to the presented specific embodiments. However, the singular or plural expression is appropriately selected for a presented situation for convenience of description, and the disclosure is not limited to the singular or plural components, and even if a component is represented in the plural, it may be composed of the singular, or even if a component is represented in the singular, it may be composed of the plural.

While the disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a home session management function (H-SMF) entity located in a home public land mobile network (HPLMN) region in a communication system, the method comprising:
selecting a user plane function (UPF) entity for a user equipment (UE) located in a visited public land mobile network (VPLMN) region;
transmitting, to the selected UPF entity, a request message for a N4 session establishment; and
as a response to the request message, receiving, from the selected UPF entity, a response message including local domain name system (DNS) server information of the UE,
wherein the DNS server information includes at least one of a DNS server address or DNS security information.

2. The method of claim 1,
wherein the UPF entity is located in the VPLMN region.

3. The method of claim 1, further comprising:
selecting the UPF entity for the UE based on at least one of a PLMN identifier (ID), serving network ID, or a mobile country code.

4. The method of claim 1,
wherein the response message further includes a UE internet protocol (IP) address.

5. A method performed by a user plane function (UPF) entity controlled by a home session management function (H-SMF) entity in a communication system, the method comprising:
receiving, from the H-SMF entity located in a home public land mobile network (HPLMN) region, a request message for a N4 session establishment;
as a response to the request message, transmitting, to the H-SMF entity, a response message including local domain name system (DNS) server information of a user equipment (UE); and
transmitting, to the UE located in a visited public land mobile network (VPLMN) region, a protocol data unit (PDU) session,
wherein the DNS server information includes at least one of a DNS server address or DNS security information.

6. The method of claim 5,
wherein the UPF entity is located in the VPLMN region.

7. The method of claim 5,
wherein the UPF entity is selected by the H-SMF, based on at least one of a PLMN identifier (ID), serving network ID, or a mobile country code.

8. The method of claim 5,
wherein the response message further includes a UE internet protocol (IP) address.

9. A home session management function (H-SMF) entity located in a home public land mobile network (HPLMN) region in a communication system, the H-SMF entity comprising:
a transceiver; and
a controller coupled with the transceiver, the controller configured to:
select a user plane function (UPF) entity for a user equipment (UE) located in a visited public land mobile network (VPLMN) region,
transmit, to the selected UPF entity, a request message for a N4 session establishment, and
as a response to the request message, receive, from the selected UPF entity, a response message including local domain name system (DNS) server information of the UE,
wherein the DNS server information includes at least one of a DNS server address or DNS security information.

10. The H-SMF entity of claim 9,
wherein the UPF entity is located in the VPLMN region.

11. The H-SMF entity of claim 9, wherein the controller is further comprised to:
select the UPF entity for the UE based on at least one of a PLMN identifier (ID), serving network ID, or a mobile country code.

12. The H-SMF entity of claim 9,
wherein the response message further includes a UE internet protocol (IP) address.

13. A user plane function (UPF) entity controlled by a home session management function (H-SMF) entity in a communication system, the UPF entity comprising:
a transceiver; and
a controller coupled with the transceiver, the controller configured to:
receive, from the H-SMF entity located in a home public land mobile network (HPLMN) region, a request message for a N4 session establishment,
as a response to the request message, transmit, to the H-SMF entity, a response message including local domain name system (DNS) server information of a user equipment (UE), and
transmit, to the UE located in a visited public land mobile network (VPLMN) region, a protocol data unit (PDU) session,
wherein the DNS server information includes at least one of a DNS server address or DNS security information.

14. The UPF entity of claim 13,
wherein the UPF entity is located in the VPLMN region.

15. The UPF entity of claim 13,
wherein the UPF entity is selected by the H-SMF, based on at least one of a PLMN identifier (ID), serving network ID, or a mobile country code.

16. The UPF entity of claim 13,
wherein the response message further includes a UE internet protocol (IP) address.
